(19) United States
(12) Patent Application Publication
(10) Pub. No.: US 2010/0026651 A1
(43) Pub. Date: Feb. 4, 2010

(54) Method and Apparatus for Navigating a Screen of an Electronic Device

(75) Inventor: Vassily N. Soloviev, St. Petersburg (RU)

Correspondence Address: MOTOROLA INC, 600 NORTH US HIGHWAY 45, W4 - 39Q, LIBERTYVILLE, IL, 60048-5343, US

(73) Assignee: Motorola Inc., Schaumburg (US)

(21) Appl. No.: 12/516,289

(22) PCT Filed: Dec. 20, 2006
(86) PCT No.: PCT/RU06/00684

§ 371 Date: May 26, 2009

(51) Int. Cl. G06F 3/041; G06F 3/033

(52) U.S. Cl. 345/173; 715/863

(57) ABSTRACT

Information is input to an electronic device by displaying a visual representation of an input option at each of a number of regions of a display screen, sensing an activation position on a first linear sensor located adjacent to a first edge of the display screen, selecting a region of the display screen in accordance with the activation position on the first linear sensor, and inputting the input option corresponding to the selected region of the display screen to the electronic device if the first linear sensor in deactivated. Optionally, a second linear sensor located adjacent to a second edge of the display screen, is used, together with the first linear sensor, to select between regions arranged in two dimensions.

### BACKGROUND

The fastest and the most convenient way to input alpha-numeric characters to an electronic device is to use a full size keyboard with full set of character keys. Unfortunately, the size of such a keyboard is unacceptable for small devices, such as portable devices.

A first approach to resolve this problem is to reduce the number of keys so that each key is associated with multiple characters and functions. There are several known variants of this approach. The common drawback of all of these variants is in the necessity to spend time to select a character. For example, in many mobile telephones the character inserted depends on the number of times the key being pressed. In addition, a pause is required between characters so as to distinguish one burst of key pressing from another. In effect, multiple key pressing is equivalent to scrolling through the character subset associated with a particular key. The current character may be indicated on the display screen to reduce number of errors.

In a modification of this approach, a separate key is used for scrolling. In this approach all of the character subsets are scrolled simultaneously and a particular character key is pressed to confirm the choice. The modification does not significantly increase input speed or ease of use. Speed may be increased if the device itself tries to predict the next character. However, if the user decides that the prediction is wrong, he or she has to manually scroll to the correct character.

In a further modification of the approach, two keys are pressed simultaneously to insert an alphabetic character. In the standard 12-key telephone keypad each key is associated with a numeric character. An alphabetic character may be inserted by pressing two neighboring keys at the same time. The main drawback of this approach is that it is difficult to create a keypad suitable for pressing one or two keys with a single finger.

The first approach is suitable for character input, but is not useful for screen navigation.

A second approach avoids the use of a keyboard by replacing it with a manipulator such as a joystick or wheel. The manipulator allows the user to scroll over single or two dimensional array of characters displayed on the screen. When the intended character is reached with the cursor a dedicated button is pressed to input this character. For instance, a wheel-based manipulator may be used to input any character, including numbers for dialing, into a mobile telephone. Benefits of manipulators include small size of the input device, which facilitates a small device size or leaves larger space for the display screen, and low cost. However, the necessity to scroll through the character set or subset reduces data input speed and ease of use.

A third approach retains a full set of character keys, but reduces the size of keys. This approach may use mechanical keys or virtual keys, displayed on a touch screen. In both cases the key size is less then the size of the human finger, so a stylus or a needle is used to press the keys. As a result, two hands are required for operation: one to hold the device and the other holds the stylus.

A fourth approach is the use of a folding keyboard. However, size restrictions for a mobile device prevent the use of a folding keyboard large enough to be compatible with human fingers.

A fifth approach uses virtual keys displayed on a touch screen that are activated with a finger. The virtual keys are significantly smaller than a finger. When the screen is touched with a finger, multiple keys are pressed simultaneously. The device selects one key, say in the center of the pushed area. The character matching the selected key is displayed in the center of the screen. If this is not the desired character, the user can move the finger until the right character appears in the center of the screen. When the displayed character is the intended one, the user has to push harder on the screen to enter it. One drawback of this approach is that user cannot see the region of the screen under the finger and has to guess which direction to move the finger when the displayed character is wrong. A further drawback is that the touch screen has to be sensitive to the amount of pressure applied. In addition, this makes the touch screen more expensive than a conventional screen. Application of pressure is detrimental to a liquid crystal display because it can cause damage.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagrammatic representation of an electronic device consistent with certain embodiments of the invention.

FIG. 2 is a flow chart of a method of operation of an electronic device consistent with certain embodiments of the invention.

FIG. 3 is a diagrammatic representation of a further electronic device, consistent with certain embodiments of the invention.

FIG. 4 is a flow chart of a further method of operation of an electronic device consistent with certain embodiments of the invention.

FIG. 5 is a diagrammatic representation of an exemplary discrete linear sensor, consistent with certain embodiments of the invention.

FIG. 6 is a diagrammatic representation of an exemplary analog linear sensor, consistent with certain embodiments of the invention.

FIG. 7 a diagrammatic representation depicting use of an electronic device consistent with certain embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to screen navigation for an electronic device. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

The present invention relates to a method and apparatus for a user to navigate a display screen of an electronic device. The approach combines the advantages of a manipulator (such as small size and low cost) with the advantages of a full character set keyboard (such as input speed and ease). In addition, the apparatus provides the user with the ability to navigate a screen (to input alphanumerical characters for example) using a single hand.

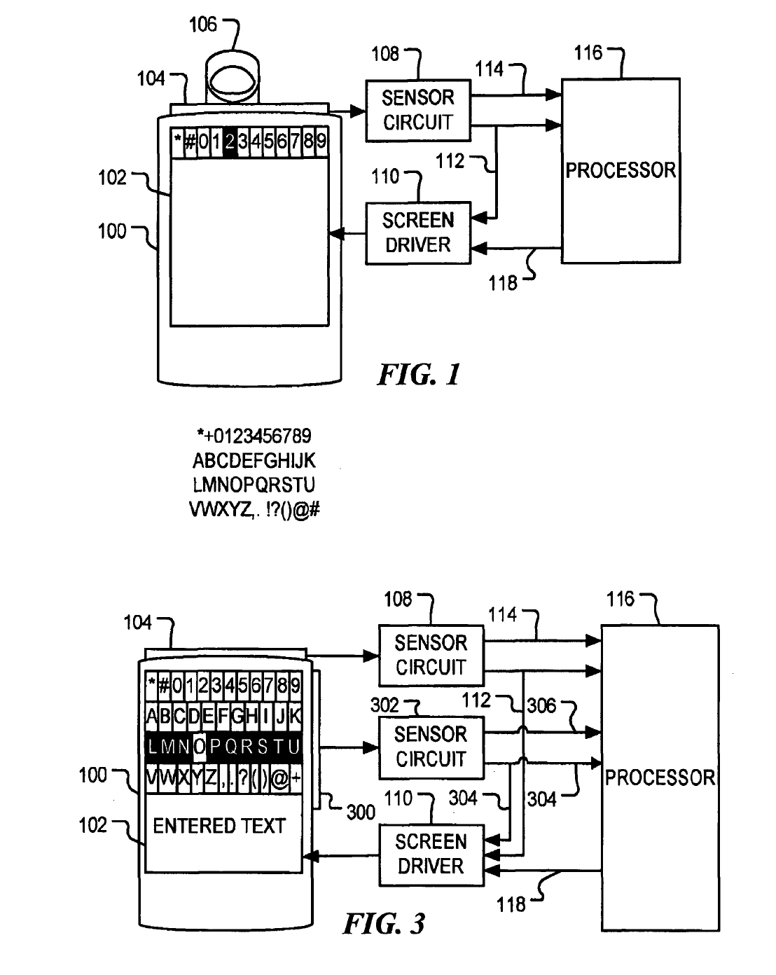

FIG. 1 is a diagrammatic representation of an electronic device consistent with a first embodiment. The electronic device 100, which may be a portable electronic device such as a cellular telephone or hand-held computer, includes a display screen 102 and a first linear sensor 104 placed at the edge of the display screen 102. For example, a horizontal sensor could be used (as in the figure) to indicate a horizontal position on the screen. Alternatively a vertical sensor could be used to indicate a vertical position on the screen. The display screen 102 includes a number of regions arranged horizontally. Each region displays a visual representation of an input option. In this example the regions contain the standard telephone symbols *, #, 0, 1, 2, 3, . . . , 9. A region may contain multiple characters (such as a menu option) or a graphical representation. The first sensor 104 is activated by a user's finger 106. The activation position along the sensor is used to select a region of the screen. In FIG. 1, the signal from the sensor is received and coded by a sensor circuit 108 to produce a position signal 110. The position signal 110 is passed to a screen driver circuit 112 that is used to control the display screen 102. The selected region may be indicated, for example, by a color change, intensity change (such as flashing), or an on-screen cursor. The user adjusts the activation position by sliding his or her finger 106 along the sensor 104 until the desired region is selected. The finger is then removed. Removal of the finger is used to indicate that the input option associated with the selected region is to be inputted. A signal 114 may be sent to the device processor 116 to indicate that the input option associated with the selected region is to be used. Alternatively, the processor can detect the loss of a position signal and used the most recent position to indicate the desired input. The processor 116 may communicate with the screen driver 112 to change the input options and/or the size and positions of the screen region.

The line of visual representations, such as characters, is displayed along the edge of the screen. To enter a character, the user pushes or touches the sensor with a finger or thumb near the intended character. In one embodiment there is a direct relationship between position on the sensor and the position on the screen. This enables a user to select the correct region more quickly. This is in contrast to a computer touch pad, for example, where finger motion is used to move a cursor, but there is no fixed relationship between a position on the touch pad and a position on the computer screen. The size of the human finger may be larger than the size of displayed symbol, thus the activated sensor region may cover multiple characters. In contrast to prior approaches, the finger does not hide any part of the screen, including displayed character. The approach allows the number of characters in the line to be varied. In addition, variable size characters may be place in different line patterns. The device selects one of the characters from the region covered and highlights it. Various rules can be used for selecting the character. The simplest rule, for instance, is to choose the most left (or right) character in the region. If the character is not intended one, the user moves the finger along the sensor. This time the device selects another character and highlights it instead of previous one. When the desired character is reached, the user releases the sensor and the device inputs the selected character. The character input process appears similar to pressing conventional keys or buttons.

Although the first linear sensor 104 is shown parallel to the top of the screen 102 in FIG. 1, the sensor could alternatively be oriented parallel to a vertical edge of the screen 102 and used to select between vertical regions of the screen. This orientation is useful for making selections from a menu, for example.

Regions of the screen contain visual representations of input options. These may be, for example, symbols, characters, graphical representations, or menu items.

The display screen 102 may be a conventional display. A touch screen may be used but is not required.

A typical mobile telephone screen allows up to 16 characters to be displayed in a single line. This is sufficient to display the set of characters required for phone number dialing, so only one sensor is required.

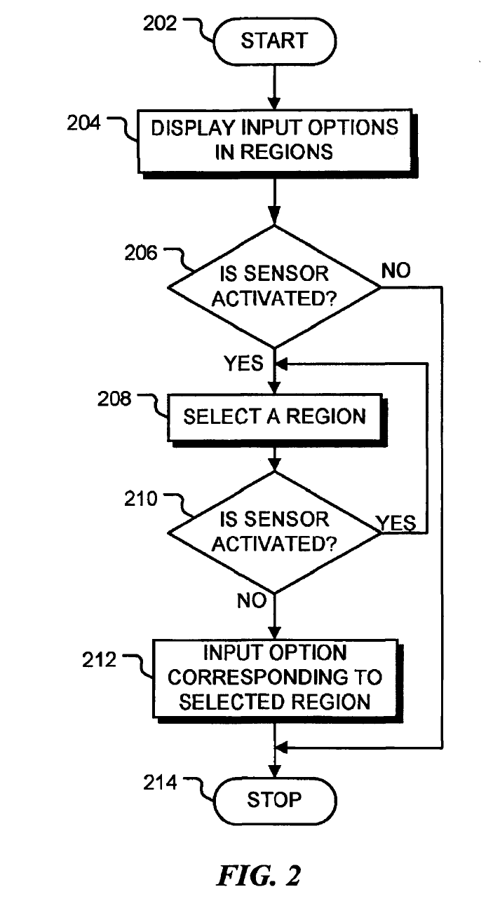

FIG. 2 is a flow chart of a method of operation of a device having a single edge sensor. Following start block 202 in FIG. 2, the input options are displayed in separate regions of the display screen at block 204. There regions are arranged substantially parallel to the linear sensor. They may be arranged horizontally or vertically. At decision block 206, a check is made to determine if the sensor has been activated (by being touched or pressed by a user, for example). If the sensor has not been activated, as depicted by the negative branch from decision block 206, the process terminates at block 214 (and may be restarted). If the sensor has been activated, as depicted by the positive branch from decision block 206, the device selects the region corresponding to the activation position on the sensor at block 208. This process may involve arbitration between neighboring regions if the regions are smaller than the width of the user's finger or thumb. If the sensor remains activated, as depicted by the positive branch from decision block 210, flow returns to block 208. If the activation position has changed, the selected region is changed, accordingly. Otherwise the selected region is unchanged. If the sensor is deactivated, as depicted by the negative branch from decision block 210, the input option corresponding to the currently selected region is input at block 212 and the process terminates a block 214.

A second linear sensor may be used to select a screen positions in a second direction. A device may include only a vertical or horizontal sensor, or may contain both vertical and horizontal sensors. A device with both vertical and horizontal sensors is shown in FIG. 3. Referring to FIG. 3, a second linear sensor 300 is used in addition to a first linear sensor 104. A second sensor circuit 302 receives and codes the sensor signal and passes it to the screen driver 112 (possibly via the processor 116). The sensor circuit also signals the processor 116 via signal line 206 to indicate if the sensor is activated or deactivated.

The whole set of numbers and Latin or Cyrillic letters may be displayed as input options by arranging them as an array (16×3, 12×4, 10×5, etc.) as shown in FIG. 3. In this case, the two sensors 104 and 200 are used to select the position in the array—one at the horizontal edge of the screen top select the column of the array and one at the vertical edge of the screen to select the row of the array. The array may be a regular array with constant size regions arranged in rows and columns, or the array may contain regions of different sizes. For example, in FIG. 3 some of the cells are wider than others to accommodate wider characters. In FIG. 3, the fourth region in the third row is highlighted.

In a first mode of operation, suitable for a beginner, the user selects vertical and horizontal positions sequentially. For example, the user selects the row pressing and releasing the vertical edge sensor as described above. Then the user selects the column pressing and releasing the horizontal edge sensor. In a second mode of operation, suitable for an experienced user, the user can hold one of the sensors continuously. In this case, the user selects one coordinate (say the row) first. Then, keeping the vertical sensor pressed, the user selects the other coordinate (say the column) pushing and releasing the horizontal edge sensor. When the horizontal sensor is released, the character is inputted. Next, the user moves the finger along the vertical edge sensor, continuing to push the sensor. When the desired row is selected, the user inputs a new character. No switching is required between these two modes of operation.

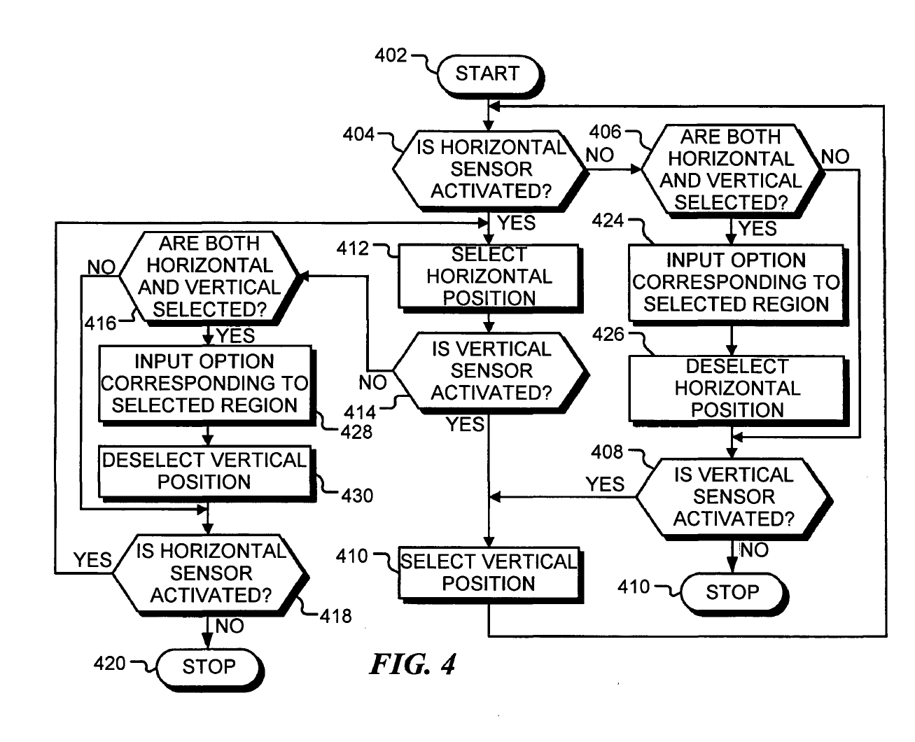

FIG. 4 is flow chart of an exemplary method of input for both modes. The input options are displayed in separate regions of the display, arranged horizontally and vertically in cells. The cells may have different sizes: a regular pattern is not required. At decision block 404, a check is made to determine if the horizontal sensor has been activated (by being touched or pressed by a user, for example). If the sensor has not been activated, as depicted by the negative branch from decision block 404, flow continues to decision block 406. If both the horizontal and vertical positions are not selected, flow continues to decision block 408. If the vertical sensor is not activated the process terminates at block 410 (and may be restated). If the horizontal sensor has been activated, as depicted by the positive branch from decision block 404, the device selects the horizontal region corresponding to the activation position on the horizontal sensor at block 412. This process may involve arbitration between neighboring horizontal regions if the regions are smaller than the width of the user's finger or thumb.

At decision block 414, a check is made to determine if the vertical sensor has been activated (by being touched or pressed by a user, for example). If the vertical sensor has not been activated, as depicted by the negative branch from decision block 414, flow continues to decision block 416. Unless both the horizontal and vertical positions are selected, flow continues to decision block 418. If the horizontal sensor is not activated the process terminates at block 420 (and may be restated).

If the vertical sensor is activated, as depicted by the positive branch from decision block 414, the vertical position is selected at block 422 and flow returns to block 404.

If the horizontal sensor is deactivated, as depicted by the negative branch from decision block 404, and both the horizontal and vertical positions have been selected, as depicted by the positive branch from decision block 406, the input option corresponding to the currently selected region is input at block 424. The horizontal position is deselected at block 426 and flow continues to decision block 408.

Similarly, if the vertical sensor is deactivated, as depicted by the negative branch from decision block 414, and both the horizontal and vertical positions have been selected, as depicted by the positive branch from decision block 416, the input option corresponding to the currently selected region is input at block 428. The vertical position is deselected at block 430 and flow continues to decision block 418.

If, after an input option is inputted, the vertical sensor is still activated, as depicted by the positive branch from decision block 408, flow continues to block 422 and the vertical position is selected. Similarly, if, after an input option is inputted, the horizontal sensor is still activated, as depicted by the positive branch from decision block 418, flow continues to block 412 and the horizontal position is selected.

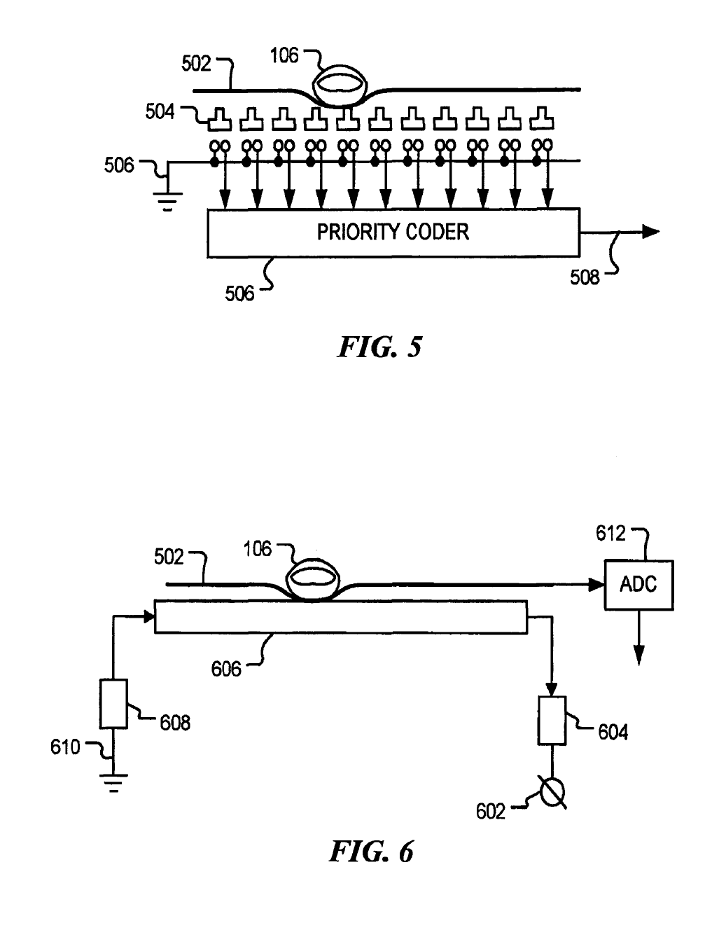

In one embodiment, the linear sensor is a discrete sensor. An exemplary discrete sensor is shown in FIG. 5. The sensor includes a deformable membrane 502 that is deformed under pressure from a user finger 106. The deformed membrane activates one or more buttons 504 of a line of buttons. Each button is small in size. The size of the button should be no larger then the size of a character or region in the display. When a switch is activated, the signal on line 506 is coupled to a priority coder 506. The priority coder 506 is part of the sensor circuit. Since button size is significantly less then human finger size, multiple buttons are pushed at the same time. The priority coder chooses one of the pushed buttons and reports its number to the processor of the device via line 508. The priority coder can be a conventional unitary-to-binary priority coder. Software and hardware implementations of such coders are well known to those of ordinary skill in the art.

In a further embodiment, the linear sensor is an analog sensor. An exemplary analog sensor is shown in FIG. 6. The sensor includes a potentiometer with a conducting membrane 502 (as opposed to a conventional potentiometer that uses a slider). The potentiometer couples a voltage supply 602 through resistors 604, 606 and 608 to a ground 610. Pushing the membrane to contact the resistor 606 couples a voltage potential to an Analog to Digital Converter (ADC). The ADC converts the voltage potential to a digital binary code and is part of the sensor circuit. The membrane 502 contacts with the resistor 606 along a relatively long segment. The membrane short-circuits a part of the resistor, so the potential received by the ADC will correspond to middle of the pushed segment.

When the membrane is pushed near the potentiometer edges, a smaller segment is short-circuited. This results in a nonlinear (hyperbolic) sensitivity near the potentiometer edges. If resistances of the segments of the potentiometer are that are not short-circuited are denoted as Rs′ and Rs″ (Rs′ being at the ground edge of the potentiometer and Rs″ being at the supply edge), the sum of these segment resistances is less than the total resistance of the potentiometer, Rs, because the segment between them is short-circuited. Near the edge of the potentiometer, one of Rs′ and Rs″ is equal to zero and the other changes resistance with finger movement. This causes a nonlinearity, since the membrane potential is given by

$$V = \frac{Rb + {Rs}^{′}}{Rb + {Rs}^{′} + {Rs}^{″} + Rt} Vpp .$$

where Rt and Rb are the resistances of elements 604 and 608, respectively and Vpp is the supply voltage.

In one embodiment the nonlinearity is compensated for in the device processor after the voltage has been sampled by the ADC. In a further embodiment the potentiometer has variable resistance per length unit. The resistors 604 and 608 are optional, but serve to bound the current through the potentiometer and improve the linearity of the sensor.

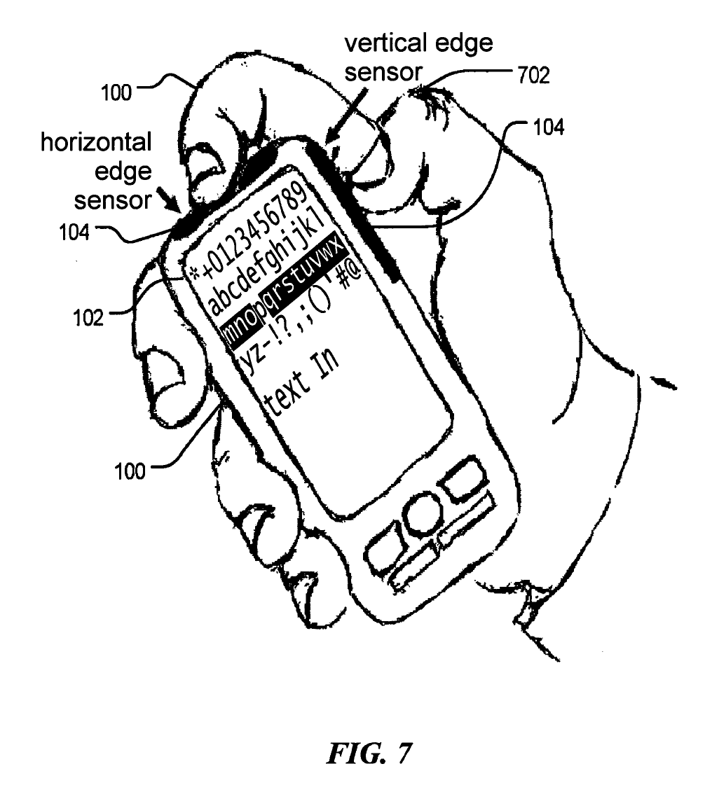

The methods and apparatus described above facilitate fast and easy input of alpha-numerical characters or other input options. The linear sensors are inexpensive and small. Further, one-handed operation of the device is possible since input options may be selected by the hand holding the device as shown in FIG. 7.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for inputting information to an electronic device, the method comprising:
displaying a visual representation of an input option at each of a plurality of regions of a display screen;
sensing an activation position on a first linear sensor located adjacent to a first edge of the display screen;
selecting a region of the display screen dependent upon the activation position on the first linear sensor; and
inputting the input option corresponding to the selected region of the display screen to the electronic device if the first linear sensor in deactivated.

2. A method in accordance with claim 1, wherein selecting a region of the display screen comprises highlighting the visual representation at the region of the display screen.

3. A method in accordance with claim 1, wherein selecting a region of the display screen comprises displaying a cursor pointing to the region of the display screen.

4. A method in accordance with claim 1, wherein the visual representation is a symbol.

5. A method in accordance with claim 1, wherein the visual representation is a menu item.

6. A method in accordance with claim 1, further comprising:
sensing an activation position on a second linear sensor located adjacent to a second edge of the display screen; and
selecting a region of the display screen dependent upon the activation position on the first sensor and the activation position on the second sensor.

7. A method in accordance with claim 6, where in the first edge of the display screen is located adjacent to the second edge of the display screen.

8. An apparatus for inputting information to an electronic device, the apparatus comprising:
a display screen operable to display a visual representation of an input option at each of a plurality of regions of the display screen;
a first linear sensor positioned adjacent to a first edge of the display screen;
a first sensor circuit operable to sense an activation position of the first linear sensor; and
a display circuit operable to control the display screen and responsive to the first sensor circuit to select a region of the display screen dependent upon the activation position of the first linear sensor.

9. An apparatus in accordance with claim 8, wherein the first sensor circuit is further operable to communicate the input option corresponding to the selected region of the display screen to a processor of the electronic device if the first linear sensor is deactivated.

10. An apparatus in accordance with claim 8, wherein the first sensor circuit is further operable to communicate the activation position to a processor of the electronic device.

11. An apparatus in accordance with claim 8, wherein the first linear sensor comprises a row of buttons.

12. An apparatus in accordance with claim 11, wherein the first sensor circuit comprises a priority coder operable to select one button from a plurality of pressed buttons or the row of buttons and to signal the selected button to the processor of the electronic device.

13. An apparatus in accordance with claim 8, wherein the first linear sensor comprises an analog sensor and wherein the first sensor circuit comprises an analog to digital converter.

14. An apparatus in accordance with claim 8, further comprising:
a second linear sensor positioned adjacent to a second edge of the display screen; and
a second sensor circuit operable to sense an activation position of the second linear sensor;
wherein the display circuit is further responsive to the second sensor circuit is operable to select a region of the display screen dependent upon the activation positions of the first and second linear sensors.

15. An apparatus in accordance with claim 14, wherein the first linear sensor is positioned to be activated by a finger of a user's hand and the second linear sensor is positioned to be activated by a thumb of the user's hand.

16. An apparatus in accordance with claim 8, further comprising a processor, wherein the processor is responsive to the first sensor circuit and is operable to control the display circuit.

17. A portable electronic device comprising the apparatus of claim 8.

18. An apparatus in accordance with claim 8, wherein the selected region is aligned with the actuation position of the first sensor.

19. An apparatus for inputting information to an electronic device, the apparatus comprising:
a display means;
a first sensing means operable to sense an activation position on a first edge of the display means;
a second sensing means operable to sense an activation position on a second edge of the display means; and
a selection means operable to select a region of the display dependent upon the activation positions of the first and second sensing means.

20. An apparatus in accordance with claim 19, further comprising a processor responsive to the first and second sensing means and operable to control the display means.

21. An apparatus in accordance with claim 19, wherein the first sensing means is positioned adjacent the top of the display means and wherein the second sensing means is positioned adjacent the side of the display means.

22. An apparatus in accordance with claim 19, wherein electronic device is adapted to be held by a user's hand, wherein the first sensing means is positioned to the sense the position of a finger of the user's hand, and wherein the second sensing means is positioned to sense the position of the thumb of the user's hand.
